(19) United States
(12) Patent Application Publication
(10) Pub. No.: US 2017/0286655 A1
(43) Pub. Date: Oct. 5, 2017

(54) WEARABLE DEVICE, SYSTEM INCLUDING THE SAME, AND OPERATION METHODS THEREOF

(71) Applicant: SK hynix Inc., Gyeonggi-do (KR)

(72) Inventors: Seung Ho SONG, Los Angeles, CA (US); SunGuk KANG, Gyeonggi-do (KR)

(21) Appl. No.: 15/085,629

(22) Filed: Mar. 30, 2016

(51) Int. Cl. G06F 21/32; G07C 9/00; H04W 12/06; G06F 1/16

(52) U.S. Cl. CPC G06F 21/32; G06F 1/163; G07C 9/00087; G07C 9/00079; H04W 12/06; G07C 9/00563; G07C 9/00904

(57) ABSTRACT

A wearable device may include: an authentication unit suitable for authenticating a user by verifying user identification information of the user; a sensor suitable for detecting contact between the authenticated user and the wearable device; a wireless communication unit suitable for wirelessly provide link success information to an electronic device requiring user authentication; and a control unit suitable for controlling the wireless communication unit to provide the link success information to the electronic device during the contact after success of the authentication of the authentication unit.

### BACKGROUND

### 1. Field

This patent document relates generally to user authentication technology, and more particularly, to a wearable electronic device and a system including the same for authenticating a user to various devices.

### 2. Description of the Related Art

A variety of electronic devices are used to store personal information. It is desirable not to allow other people to use the electronic devices by authenticating users of the electronic devices. Similarly, it is desirable only for an authenticated user of a vehicle to use it. Further, it is desirable that a door, such as a door of a vehicle, is opened only for authenticated people. That is, various electronic devices, vehicles, and doors must remain locked to people except for one or more authenticated users.

For securing the electronic devices, vehicles and buildings of the door, it is necessary to authenticate the user. Authentication through password, fingerprint recognition, and iris pattern recognition are well known. A password may be broken or exposed and thus vulnerable to the authentication. Also, generally, it may be inconvenient for a user to authenticate himself with his fingerprint or iris for each access. Moreover, application of the fingerprint or iris pattern recognition technologies in the electronic devices, vehicles and buildings are rather costly.

### SUMMARY

Various embodiments are directed to a wearable device, a system including the same and a method of operating thereof capable of authenticating a user to various devices.

In an embodiment, a wearable device may include: an authentication unit suitable for authenticating a user by verifying user identification information of the user; a sensor suitable for detecting contact between the authenticated user and the wearable device; a wireless communication unit suitable for wirelessly provide link success information to an electronic device requiring user authentication; and a control unit suitable for controlling the wireless communication unit to provide the link success information to the electronic device during the contact after success of the authentication of the authentication unit.

The sensor may further detect separation of the authenticated user from the wearable device.

The user identification information may include one or more of: a skin pattern; a blood vessel pattern; an iris pattern; an ear canal pattern; a DNA sequence; and a heart rate pattern.

The sensor may detect the contact by sensing touch of the authenticated user to the wearable device.

The wearable device may be included in one of: a ring; a watch; glasses; a bracelet; and an ear plug.

The wearable device may be one or more of: a vehicle locking device; a computer; a mobile device; a door lock; and a computer input device, and the electronic device is unlocked during the provision of the link success information.

In an embodiment, a system may include: an electronic device requiring user authentication; and a wearable device suitable for authenticating a user, detecting contact of the authenticated user thereto, and providing link success information to the electronic device during the contact after success of the authenticating of the user. The electronic device may be unlocked during the provision of the link success information.

The wearable device may include: an authentication unit suitable for authenticating the user by verifying user identification information of the user; a sensor suitable for detecting the contact; a wireless communication unit suitable for wirelessly provide the link success information to the electronic device; and a control unit suitable for controlling the wireless communication unit to provide the link success information to the electronic device during the contact after success of the authentication of the authentication unit.

The sensor may further detect separation of the authenticated user from the wearable device.

The sensor may detect the contact by sensing touch of the authenticated user to the wearable device.

The user identification information may include one or more of: a skin pattern; a blood vessel pattern; an iris pattern; an ear canal pattern; a DNA sequence; and a heart rate pattern.

The wearable device may be included in one of: a ring; a watch; glasses; a bracelet; and an ear plug.

The electric device may be one or more of: a vehicle locking device; a computer; a mobile device; a door lock; and a computer input device.

In an embodiment, an operation method of a wearable device may include: authenticating a user by verifying user identification information of the user; detecting contact between the authenticated user and the wearable device; and providing a link success information to an electronic device requiring user authentication during the contact after success of the authenticating of the user.

The operation method may further include detecting separation of the authenticated user from the wearable device

The separation may be detected when the contact is not detected for a predetermined time.

The user identification information may include one or more of: a skin pattern; a blood vessel pattern; an iris pattern; an ear canal pattern; a DNA sequence; and a heart rate pattern.

In an embodiment, there is provided an operation method of a system which includes a wearable device and an electronic device requiring user authentication. The operation method may include authenticating, at the wearable device, a user by verifying user identification information of the user; detecting, at the wearable device, contact between the authenticated user and the wearable device; providing, at the wearable device, a link success information to the electronic device during the contact after success of the authenticating of the user; and receiving, at the electronic device, the link success information thereby unlocking the electronic device.

The operation method may further include detecting, at the wearable device, separation of the authenticated user from the wearable device.

The separation may be detected when the contact is not detected for a predetermined time.

### BRIEF DESCRIPTION OF THE DRAWINGS

FIG. 1 is a configuration diagram of a wearable device, according to an embodiment of the present invention.

FIG. 2 is a simplified schematic of a wearable device having the shape of a ring, according to an embodiment of the present invention.

FIG. 3 is a simplified schematic of a wearable device having the shape of a watch, according to an embodiment of the present invention.

FIG. 4 is a diagram illustrating a wearable device having the shape of glasses, according to an embodiment of the present invention.

FIG. 5 is a diagram illustrating an example of a wearable system including a vehicle locking electronic device, according to an embodiment of the present invention.

FIG. 6 is a diagram illustrating an example of wearable system including an electronic door lock of a house or an office, according to an embodiment of the present invention.

FIG. 7 is a diagram illustrating an example of a wearable system including a mobile device, according to an embodiment of the present invention.

FIG. 8 is a diagram illustrating an example of a wearable system including a computer keyboard according to an embodiment of the present invention.

FIG. 9 is a flowchart illustrating an operation method of a wearable system including a wearable device for unlocking an electronic device.

### DETAILED DESCRIPTION

Various embodiments will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the present invention to those skilled in the art. Throughout the disclosure, like reference numerals refer to like parts throughout the various figures and embodiments of the present invention.

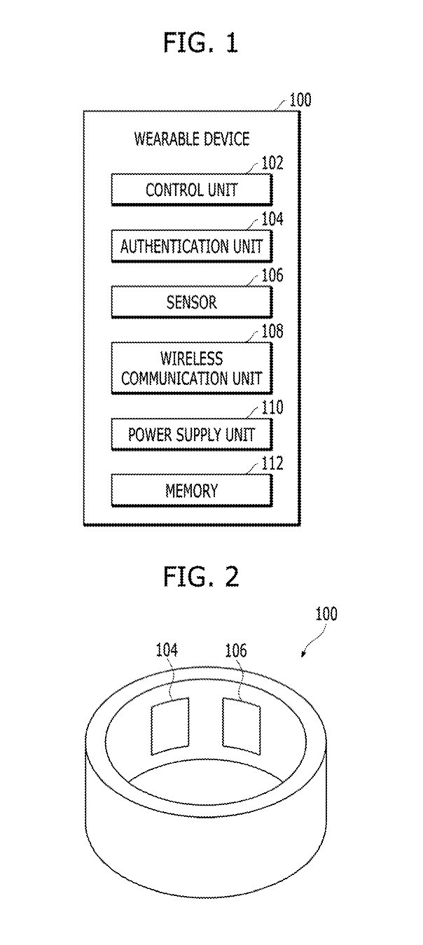

FIG. 1 is a configuration diagram of a wearable device 100, according to an embodiment of the present invention. FIG. 1 illustrates components included in the wearable device 100, and does not illustrate the shape of the wearable device 100. The wearable device may be implemented in a variety of shapes as will be described later.

Referring to FIG. 1, the wearable device 100 may include a control unit 102, an authentication unit 104, a sensor 106, a wireless communication unit 108, a power supply unit 110. The wearable device 100 may further include a memory 112 used by the control unit 102.

The authentication unit 104 may verify user identification information of the wearable device 100. The user identification information may be different for each user. For example, the identification information may include one or more of a skin pattern, a blood vessel pattern, an iris pattern, an ear canal pattern, a DNA sequence, and a heart rate pattern. The skin pattern may include a fingerprint, a palm pattern, a hand pattern, a fist pattern, a hand back pattern, and a wrist pattern.

The sensor 106 may detect whether or not the user wears the wearable device 100. For example, the sensor 106 may check whether there is contact between the user and the wearable device 100. For example, the sensor 106 may include a touch sensor which uses one or more of various methods of detection, such as, for example, a capacitive method and or a resistive method. The sensor 106 may be integrated into the authentication unit 104. The sensor may be separate from the authentication unit.

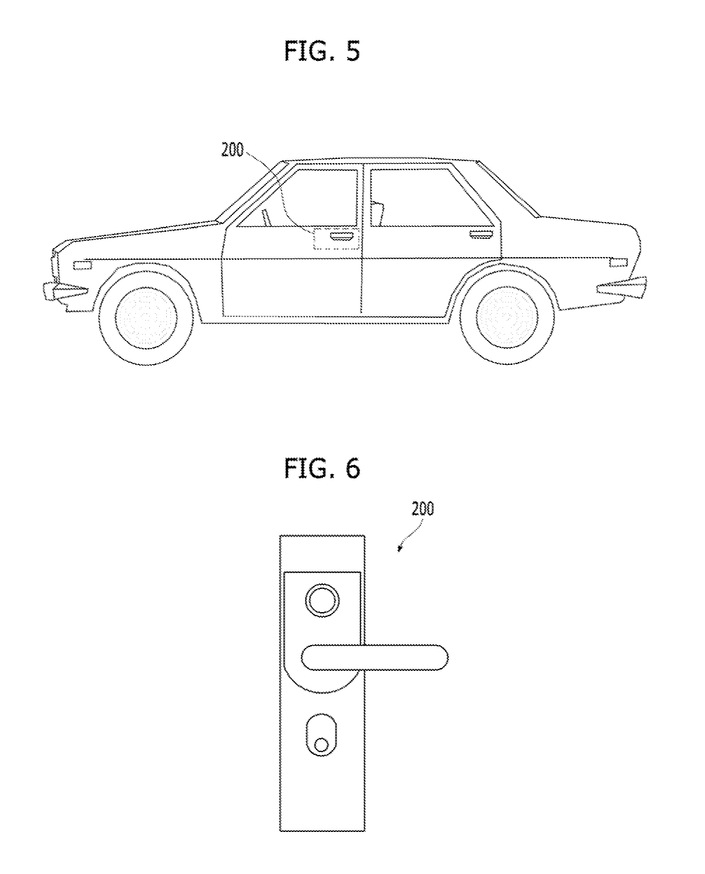

The wireless communication unit 108 may enable the wearable device 100 to communicate with other electronic devices 200 (refer to FIGS. 5 to 8) according to an arbitrary suitable protocol. In particular, the wearable device 100 may provide the electronic devices 200 with link success information for unlocking the electronic devices 200.

The memory 112 may include one or more different types of memories among various volatile and nonvolatile memories. The memory 112 may store data for the verification of the user identification information performed by the authentication unit 104, and store data for the control unit 102. The memory 112 may be integrated into or with another component of the wearable device 100. For example, the memory 112 may be integrated into or with the control unit 102 of the wearable device 100.

The power supply unit 110 may supply power for the wearable device 100. The power supply unit 110 may include one or more batteries. The batteries may be rechargeable batteries.

The control unit 102 may control the overall operation of the wearable device 100. For example the control unit 102 may execute various applications, such as, for example, operating system applications and firmware applications, which are stored in the memory 112.

The control unit 102 may control the wireless communication unit 108 to transmit link success information to the electronic devices 200 until the sensor 106 detects that the user takes off the wearable device 100 after the authentication unit 104 successfully verifies the user identification information of the user. The link success information may be used to unlock the electronic devices 200.

FIGS. 2 to 4 illustrate various forms of the wearable device 100.

Referring to FIG. 2, the wearable device 100 may have the shape of a ring. In this case, the authentication unit 104 may be positioned on the inner surface of the ring, and identify a user by checking the skin pattern of a user's finger. The sensor 106 may also be positioned on the inner surface of the ring, and check whether touching contact with the user's finger is maintained, in order to determine whether the user wears the wearable device 100. In addition to the sensor 106 and the authentication unit 104, the other components of the wearable device may be mounted on or in the body of the ring.

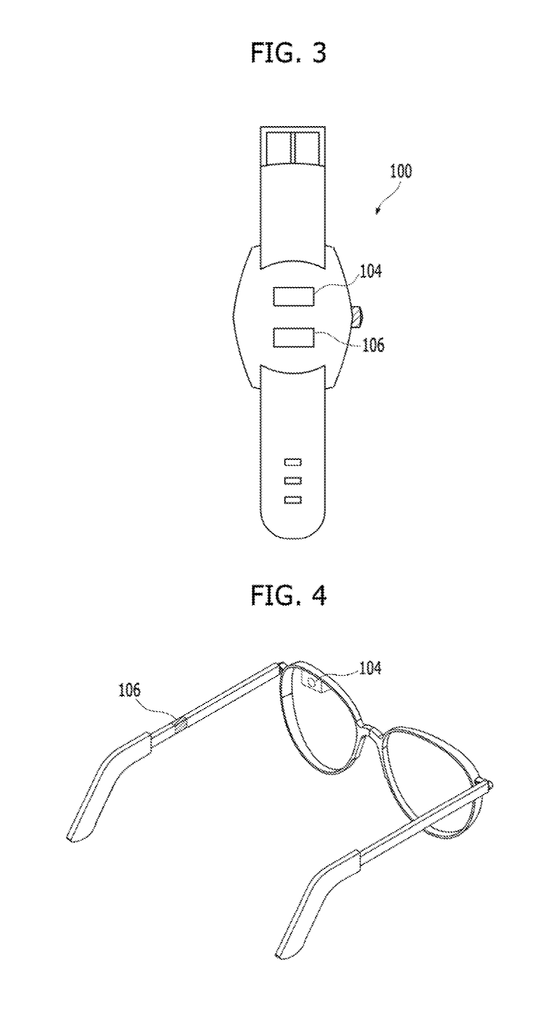

Referring to FIG. 3, the wearable device 100 may be or be included in a watch or watch like device. For example, the wearable device may be or included in a device having the shape of a watch without necessary having the functionalities of a watch. For example, the authentication unit 104 may be positioned on the rear surface of a watch or watch-like device, and identify a user by checking the skin pattern of the user's hand back. The sensor 106 may also be positioned on the rear surface of the watch or watch-like device, and check whether touching contact with the user is maintained for determining whether the user wears the wearable device 100. In addition to the sensor 106 and the authentication unit 104, the other components of the wearable device may be mounted in the watch or the watch-like device.

In a different embodiment, wearable device 100 may be or included in watch band. For example, the authentication unit 104 and the sensor 106 may be positioned on the inner surface of a watch band. The remaining components of the wearable device 100 may be inserted in or mounted on the watch band on in or on the watch body.

Referring to FIG. 4, the wearable device 100 may be or included in a device having the shape of glasses. The glasses may be any type of glasses. For example, the authentication unit 104 may be positioned around or inside a lens of the glasses for identifying a user by checking, for example, the iris pattern of the user. The sensor 106 may be positioned on a leg of the glasses. For example, the sensor 106 may be positioned on a leg of the glasses at an area of the leg where the leg touches the ear of the user for checking whether touching contact (direct physical contact) with the user is maintained, in order to determine whether the user wears the wearable device 100. In addition to the sensor 106 and the authentication unit 104, the other components of the wearable device may be mounted on the or in the glasses.

FIGS. 2 to 4 illustrate that the wearable device 100 may have the shape of a ring, a watch, or glasses. In addition, however, the wearable device 100 may have various shapes, such as, for example, a bracelet and an ear plug, which can be worn by the user. Also, the sensor 106 may be configured to detect direct physical contact, i.e., touch the skin of a user, however, the invention may not be limited in this way. For example, the sensor 106 may be configured to detect indirect contact with the user through a user's clothing. Likewise the authentication unit 104 may or may not be in direct contact with the user.

FIGS. 5 to 8 illustrate various electronic devices 200 which may be unlocked by the wearable device 100. The electronic devices 200 may be switched from a locked state to an unlocked state in response to link success information received from the wearable device 100.

Referring to FIG. 5 the electronic device 200 may correspond to a vehicle locking device. When the electronic device 200 is a vehicle locking device, the door of the vehicle may not be opened and or the vehicle may not be started, in a locked state. On the other hand the door of the vehicle may be opened and or the vehicle may be started, in an unlocked state.

Referring to FIG. 6, the electronic device 200 may correspond to a door lock used in a house or office. When the electronic device 200 is a door lock, the door may not be opened in a locked state, but opened in an unlocked state.

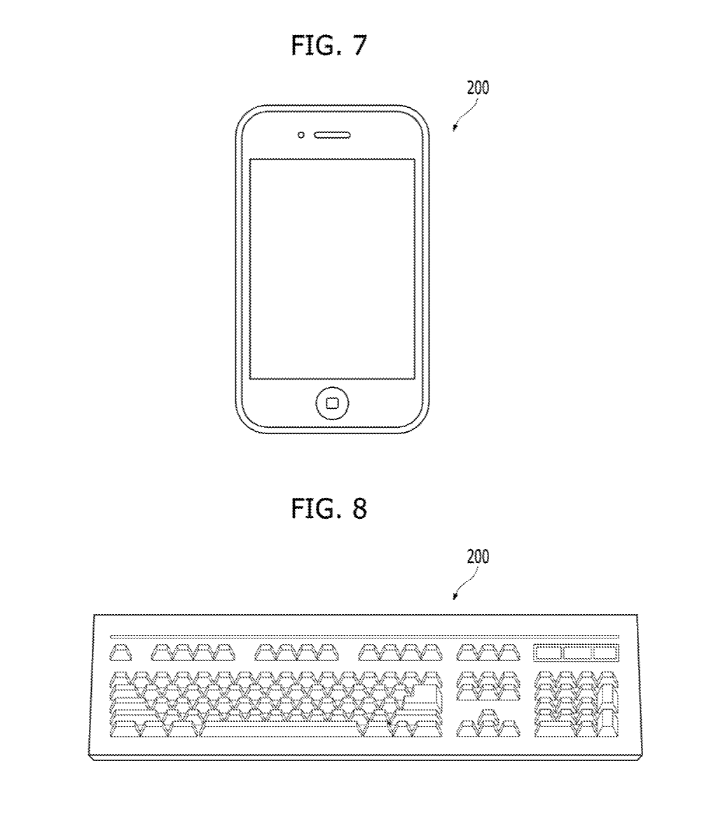

Referring to FIG. 7, the electronic device 200 may correspond to a mobile device. When the electronic device 200 is a mobile device, the use of the mobile device and the access to information stored in the mobile device may be blocked in a locked state. On the other hand, the use of the mobile device and the access to information stored in the mobile device can be allowed in an unlocked state.

Referring to FIG. 8 the electronic device 200 may correspond to a computer input device such as, for example, a keyboard. When the electronic device 200 is a keyboard a key input may be disabled in a locked state, whereas a key input is possible in an unlocked state.

FIGS. 5 to 8 illustrate that the electronic device 200 may be a vehicle locking device, a door lock, a mobile device, and a keyboard. However, the invention is not limited to such devices. The electronic device 200 may correspond to one of various other devices, such as, for example, computer input devices.

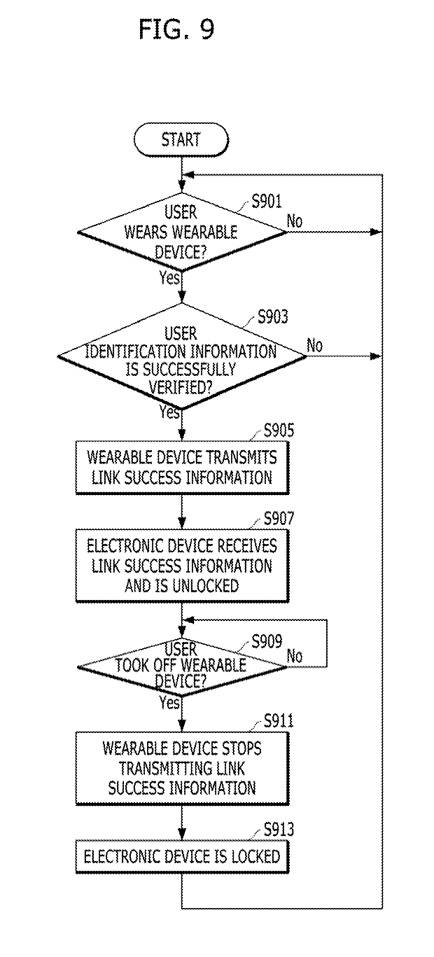

FIG. 9 illustrates an example of the operation of a system including the wearable device 100 and the electronic device 200.

Referring to FIG. 9, the wearable device 100 may check whether a user wears the wearable device 100, at step S901. This process may include the sensor 106 of the wearable device 100 sensing whether the user wears the wearable device 100 for example by sensing a touching contact between the wearable device 100 and the user.

When the user is detected to wear the wearable device 100 (Y at step S901), the user identification information may be verified by the authentication unit 104 of the wearable device 100 at step S903. The control unit 102 may check whether the user identification information detected by the authentication unit 104 coincides with identification information stored in the memory 112, and determine whether the identification information is successfully verified.

When the user identification information is successfully verified (Y at step S903), the control unit 102 of the wearable device 100 may control the wireless communication unit 108 to transmit link success information at step S905. The link success information may represent success of the user authentication and may cause unlocking of the electronic device 200 upon receiving the link success information.

The electronic device 200 may receive the link success information, and the electronic device 200 may be switched to an unlocked state according to the provided link success information at step S907. At this time, a plurality of electronic devices 200 may receive the link success information provided from a single wearable device 100 on condition that each of the electronic devices 200 and the single wearable device 100 should authenticate each other and signal channel between each of the electronic devices 200 and the single wearable device 100 should be different and secured from another signal channel for another electronic devices 200 and the wearable device 100 of another user. For example, during transmission of the link success information from the single wearable device 100 due to the success of user authentication at step S903, a mobile device as well as a vehicle of the authenticated user may be unlocked upon receipt of the transmitted link success information provided that they are within the coverage of the transmitted link success information signal. Furthermore, when the authenticated user of the single wearable device 100 stands in front of a door, the door if it is within the coverage of the transmitted link success information signal may also be unlocked.

Then, the wearable device 100 may detect separation of the authenticated user from the wearable device 100 at step S909. At this time, the separation of the authenticated user from the wearable device 100 may be detected by the sensor 106 of the wearable device 100. Since a gap inevitably exists between the user and the wearable device 100, the contact between the authenticated user and the wearable device 100 may not be sensed for a short time, even though the authenticated user keeps in wearing the wearable device 100. Thus, when the authenticated user's contact to the wearing device 100 is not detected for a predetermined time (for example, five seconds) or more by the sensor 106, the sensor 106 may detect the separation of the authenticated user from the wearable device 100.

When the sensor 106 detects a separation of the authenticated user from the wearable device 100 (Y at step S909), the wearable device 100 may stop transmitting the link success information at step S911. No transmission of the link success information may be accomplished through transmission stop of the link success information from the wireless communication unit 108, or transmission of separation detect signal from the wireless communication unit 108.

When the transmission of the link success information is stopped, the electronic device 200 may be locked at step S913.

According to the embodiments of the present invention, the electronic devices 200 of the user can be unlocked without additional authentication during contact between the user and the wearable device 100 after a one-time authentication of the user by the wearable device 100. Thus, the user authentication process for unlocking the electronic devices 200 becomes very convenient. Furthermore, when others wear the wearable device 100 or the user does not wear the wearable device 100, the electronic devices 200 of the user maintain the locked state, thereby providing strong security.

According to the embodiments of the present invention, the wearable device, the system, and the operation methods thereof can authenticate a user to various devices through a safe and simple method.

Although various embodiments have been described for illustrative purposes, it will be apparent to those skilled in the art that various changes and modifications may be made without departing from the spirit and/or the scope of the invention as defined in the following claims.

What is claimed is:

1. A wearable device comprising:
an authentication unit suitable for authenticating a user by verifying user identification information of the user;
a sensor suitable for detecting whether the user is wearing the wearable device;
a wireless communication unit suitable for wirelessly provide link success information to an electronic device requiring user authentication; and
a control unit suitable for controlling the wireless communication unit to provide the link success information to the electronic device during the contact after success of the authentication of the authentication unit.

2. The wearable device of claim 1, wherein the sensor detects whether the user is in physical contact with the wearable device.

3. The wearable device of claim 1, wherein the user identification information comprises one or more of:
a a skin pattern;
a blood vessel pattern;
an iris pattern;
an ear canal pattern;
a DNA sequence; and
a heart rate pattern.

4. The wearable device of claim 2, wherein the sensor detects the contact by sensing touch of the authenticated user to the wearable device.

5. The wearable device of claim 1, wherein the wearable device is or is included in one of:
a ring;
a watch;
glasses;
a bracelet; and
an ear plug.

6. The wearable device of claim 1,
wherein the electronic device is one or more of:
a vehicle locking device;
a computer;
a mobile device;
a door lock; and
a computer input device, and
wherein the electronic device is unlocked upon receipt by the electronic device of the link success information.

7. A system comprising:
an electronic device requiring user authentication; and
a wearable device suitable for authenticating a user, detecting contact of the authenticated user thereto, and providing link success information to the electronic device during the contact after success of the authenticating of the user,
wherein the electronic device is unlocked during the provision of the link success information.

8. The system of claim 7, wherein the wearable device comprises:
an authentication unit suitable for authenticating the user by verifying user identification information of the user;
a sensor suitable for detecting the contact;
a wireless communication unit suitable for wirelessly provide the link success information to the electronic device; and
a control unit suitable for controlling the wireless communication unit to provide the link success information to the electronic device during the contact after success of the authentication of the authentication unit.

9. The system of claim 8, wherein the sensor further detects separation of the authenticated user from the wearable device.

10. The system of claim 8, wherein the sensor detects the contact by sensing touch of the authenticated user to the wearable device.

11. The system of claim 7, wherein the user identification information comprises one or more of:
a skin pattern;
a blood vessel pattern;
an iris pattern;
an ear canal pattern;
a DNA sequence; and
a heart rate pattern.

12. The system of claim 7, wherein the wearable device is included in one of:
a ring;
a watch;
glasses;
a bracelet; and
an ear plug.

13. The system of claim 7, wherein the electric device is one or more of:
a vehicle locking device;
a computer;
a mobile device;
a door lock; and
a computer input device.

14. An operation method of a wearable device, comprising:
authenticating a user by verifying user identification information of the user;
detecting contact between the authenticated user and the wearable device; and
providing a link success information to an electronic device requiring user authentication during the contact after success of the authenticating of the user.

15. The operation method of claim 14, further comprising detecting separation of the authenticated user from the wearable device.

16. The operation method of claim 15, wherein the separation is detected when the contact is not detected for a predetermined time.

17. The operation method of claim 14, wherein the user identification information comprises one or more of:
a skin pattern;
a blood vessel pattern;
an iris pattern;
an ear canal pattern;
a DNA sequence; and
a heart rate pattern.

18. An operation method of a system which includes a wearable device and an electronic device requiring user authentication, the operation method comprising:
authenticating, at the wearable device, a user by verifying user identification information of the user;
detecting, at the wearable device, contact between the authenticated user and the wearable device;
providing, at the wearable device a link success information to the electronic device during the contact after success of the authenticating of the user; and
receiving, at the electronic device, the link success information thereby unlocking the electronic device.

19. The operation method of claim 18, further comprising detecting, at the wearable device, separation of the authenticated user from the wearable device.

20. The operation method of claim 19, wherein the separation is detected when the contact is not detected for predetermined time.
